(19) United States
(12) Patent Application Publication
(10) Pub. No.: US 2003/0137417 A1
(43) Pub. Date: Jul. 24, 2003

(54) TV remote pager

(76) Inventor: Earl G. Vought, Shamong, NJ (US)

Correspondence Address: Earl G. Vought, 385 Forked Neck Rd, Shamong, NJ, 08088, US

(21) Appl. No.: 10/347,100

(22) Filed: Jan. 17, 2003

Related U.S. Application Data
(60) Provisional application No. 60/349,325, filed on Jan. 18, 2002.

(51) Int. Cl. G08B 13/14

(52) U.S. Cl. 340/571; 340/539.1; 340/568.1

(57) ABSTRACT

The Television. Remote Pager, is an electronic improvement that renders previous remote controls obsolete. Simply press a button on the television. set and the remote control is found and located by its' beeping sounds.

This application claims the benefit of the Provisional Patent Application No. 60/349,325 Filing date: Jan. 18, 2002

### CROSS REFERENCE TO RELATED APPLICATIONS

Provisional Patent Application confirmation no. 1891

Application No. 60/349,325, filing date Jan. 18, 2002.

Foreign filing license granted Feb. 5, 2002.

### STATEMENT REGARDING FEDERALLY SPONSORED RESEARCH DEVELOPMENT

Non applicable

### REFERENCE TO A MICROFICHE APPENDIX

Non applicable

### BACKGROUND OF THE INVENTION

This invention came about to satisfy the need to locate the remote when it was lost or misplaced. Previous television remote controllers were always misplaced and difficult to find.

### BRIEF SUMMARY OF THE INVENTION

The television remote pager is my answer to the problem of finding the remote. Previously all remotes once misplaced were difficult to find. The objective of this invention is to be able to locate the remote controller at any and all times.

### BRIEF DESCRIPTION OF THE SEVERAL VIEWS OF THE DRAWING

Non applicable

### DETAILED DESCRIPTION OF THE INVENTION

This improvement consists of several components added to existing devices, namely the television and its the remote controller. The television would have a special pager function, when the remote pager button is pressed this sends a signal via infra red or radio frequency, from the television to a sensor causing an electronic buzzer in the remote to activate, so that it heard, located, and used very easily. The remote control with pager sensor begins with a conventional remote, but has a sensor and buzzer placed within it's case emitting a loud buzzing or chirping noise when receiving the signals from the television.

What I claim as my invention is:

1. This improvement and adaptation to the television and remote will greatly enhance the ease and pleasures of both.

2. No longer will you search for a misplaced remote, just press the pager button on and the television. and the remote will begin to chirp or buzz, thereby locating the remote.

3. This adaptation and improvement to the existing television. remote is accomplished by infra red or radio frequency signal being sent from the television. when the pager (locator) button is depressed, the sensor in the remote is activated, thereby causing an audible chirping or beeping sound.
